(19) United States
(12) Patent Application Publication
(10) Pub. No.: US 2017/0277423 A1
(43) Pub. Date: Sep. 28, 2017

(54) INFORMATION PROCESSING METHOD AND ELECTRONIC DEVICE

(71) Applicant: Lenovo (Beijing) Limited, Beijing (CN)

(72) Inventor: Zhen Xin Xi, Beijing (CN)

(21) Appl. No.: 15/470,035

(22) Filed: Mar. 27, 2017

(30) Foreign Application Priority Data
Mar. 28, 2016 (CN) 201610184581.8

(51) Int. Cl. G06F 3/0488; G06K 9/00

(52) U.S. Cl. CPC G06F 3/04883; G06K 9/00154

(57) ABSTRACT

One embodiment provides a method, including: receiving, at an electronic device, a handwriting input operation by a user; acquiring, using a processor, a first input feature information associated with the handwriting input operation; and generating, using a processor, an index based on the first input feature information. Other aspects are described and claimed.

### CLAIM FOR PRIORITY

This application claims priority to Chinese Application No. 201610184581.8, filed on Mar. 28, 2016, which is fully incorporated by reference herein.

### FIELD

The subject matter described herein relates to the field of electronic devices, more specifically, it relates to an information processing method and electronic device.

### BACKGROUND

As a common identification method, signatures are applied in various fields. For example, a user usually performs a signature action after a swiped transaction to complete card swiping.

### BRIEF SUMMARY

In summary, one aspect provides a method, comprising: receiving, at an electronic device, a handwriting input operation by a user; acquiring, using a processor, a first input feature information associated with the handwriting input operation; and generating, using a processor, an index based on the first input feature information.

Another aspects provides an electronic device, comprising: a handwriting input component; a processor operatively coupled to the handwriting input component; a memory device that stores instructions executable by a processor to: receive a handwriting input operation by a user; acquire a first input feature information associated with the handwriting input operation; and generate an index based on the first input feature information.

A further aspect provides a program product, comprising: a storage device that stores code, the code being executable by a processor and comprising: code that receives, at an electronic device, a handwriting input operation by a user; code that acquires, using a processor, a first input feature information associated with the handwriting input operation; and code that generates, using a processor, an index based on the first input feature information.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 is a schematic flow diagram illustrating an information processing method according to an embodiment;

FIG. 2 is a schematic flow diagram illustrating an information processing method according to an embodiment;

FIG. 3 is a schematic flow diagram illustrating an information processing method according to an embodiment;

FIG. 4 is a structural schematic diagram showing a display according to an embodiment;

FIG. 5 is a structural schematic diagram showing another display according to an embodiment;

FIG. 6 is a schematic flow diagram illustrating an information processing method according to an embodiment;

FIG. 7 is a schematic flow diagram illustrating an information processing method according to an embodiment;

FIG. 8 is a structural schematic diagram of a display showing two written handwritings according to an embodiment;

FIG. 9 is a schematic flow diagram illustrating an information processing method according to an embodiment;

FIG. 10 is a schematic flow diagram illustrating an information processing method according to an embodiment;

FIG. 11 is a schematic flow diagram illustrating an information processing method according to an embodiment;

FIG. 12 is a schematic flow diagram illustrating an information processing method according to an embodiment;

FIG. 13 is a schematic structural block diagram illustrating an electronic device according to an embodiment;

FIG. 14 is a schematic structural block diagram illustrating an electronic device according to an embodiment;

FIG. 15 is a schematic structural block diagram illustrating an electronic device according to an embodiment;

FIG. 16 is a schematic structural block diagram illustrating an electronic device according to an embodiment.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Situations may arise where other users may emulate the handwriting of a signatory to forge their signature. In these instances the signatory cannot determine, from the signed handwriting, that the signature is not his/her own signature, even if afterwards the signatory denies it. Since the signature cannot be traced, dispute cannot be settled when the dispute occurs because the signatory denies some signature.

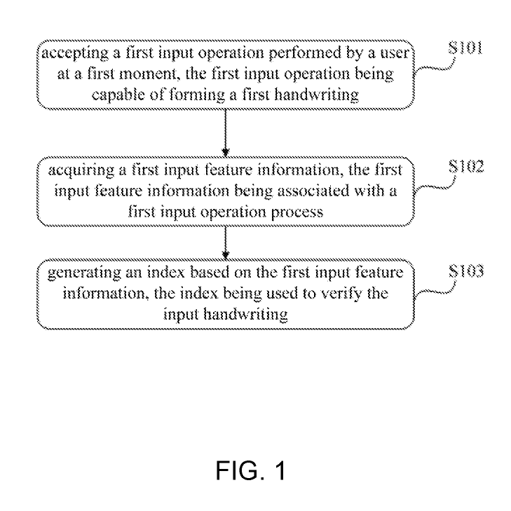

Referring now to FIG. 1, a flow diagram of an information processing method according to an embodiment is illustrated. In an embodiment, the electronic device may be an electronic device in the form of a desktop, a notebook, a tablet computer, a mobile phone, a smart TV, a smart watch, a wearable device and the like. Furthermore, in an embodiment, the electronic device is capable of performing an operation of inputting handwriting.

At step S101, an embodiment accepts a first input operation performed by a user at a first moment. The first input operation is capable of forming a first handwriting, wherein the user inputs handwritten characters, such as a signature, in a particular input area to form handwriting in a corresponding area. In an embodiment, at the first moment, the first input operation performed by the user in the particular input area is accepted and the first input operation forms the first handwriting in the corresponding area. In an embodiment, the first moment may be a moment at which the user has to perform signature. For example, the first moment may be a moment at which the user swipes a card and signs, a moment at which the user signs for business, etc.

At step S102, an embodiment acquires a first input feature information. The first input feature information is associated with a first input operation process, wherein the first input feature information is acquired based on a process of the first input operation. In an embodiment, the first input feature information includes a feature in the process in which the first input operation is performed at the first moment to form the first handwriting. In an embodiment, an analysis can be made to obtain the user who performs the first input operation and a feature in the process in which the user performs the first input operation based on the first input feature information.

At step S103, an embodiment generates an index based on the first input feature information, the index being used to verify the input handwriting. The index is generated based on the first input feature information. The index corresponds to the first input feature information so that verification can be realized for the handwriting input at the first moment, as well as the input process based on the index to realize a traceable signature process based on verification of the handwriting content by the index. As such, when dispute occurs because the user denies signature, verification of an input signature information may be realized based on the index. In an embodiment, the first input feature information may be recorded in the index. For example, when information with less data volume is included in the first feature information, the index may be directly recorded in the form of a QR code and the like.

Therefore, in an embodiment, an information processing method provided in the embodiment comprises: accepting a first input operation performed by the user at a first moment, the first input operation being capable of forming a first handwriting; acquiring a first input feature information, the first input feature information being associated with a first input operation process; generating an index based on the first input feature information, the index being used to verify the input handwriting content. With the aforementioned embodiments, by performing acquisition for the first input feature information associated with the first input operation process which forms the first handwriting, and generating an index based on the first input feature information to realize performing verification for the input handwriting content based on the index, a traceable signature process is realized. As such, when the dispute occurs because the user denies signature, verification can be performed for the to-be-realized input signature information based on the index, and in turn, the dispute issue is resolved and user experience is improved.

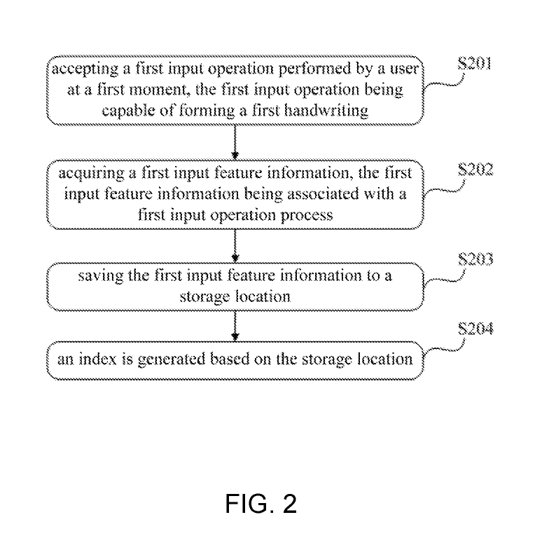

Referring now to FIG. 2, a flow diagram of an information processing method according to an embodiment is illustrated.

At step S201, an embodiment accepts a first input operation performed by a user at a first moment, the first input operation being capable of forming a first handwriting. At step S202, an embodiment acquires a first input feature information, the first input feature information being associated with a first input operation process.

At step S203, an embodiment saves the first input feature information to a storage location, wherein the electronic device is associated with a default storage location. More particularly, the first input feature information is saved in the storage location. In an embodiment, the storage location may be a storage space in the electronic device, may be a cloud storage space associated with the electronic device, or may be a server storage associated with the electronic device.

At step S204, in an embodiment, an index is generated based on the storage location. The index is used to acquire the first input feature information from the storage location. The index is generated from the storage location, so that the first input feature information can be acquired from the storage location based on the index, and in turn, verification can be performed for the first input feature information at a subsequent time, or verification is performed for the input feature information of other tracks based on the first input feature information.

Therefore, in an embodiment, an information processing method comprises: saving the first input feature information to a storage location and generating an index based on the storage location. The index is used to acquire the first input feature information from the storage location. With the aforementioned method, the index is generated based on the save location which stores the first input feature information, such that performing verification for the stored first input feature information, or performing verification for the input feature information of other tracks based on the first input feature information can be realized.

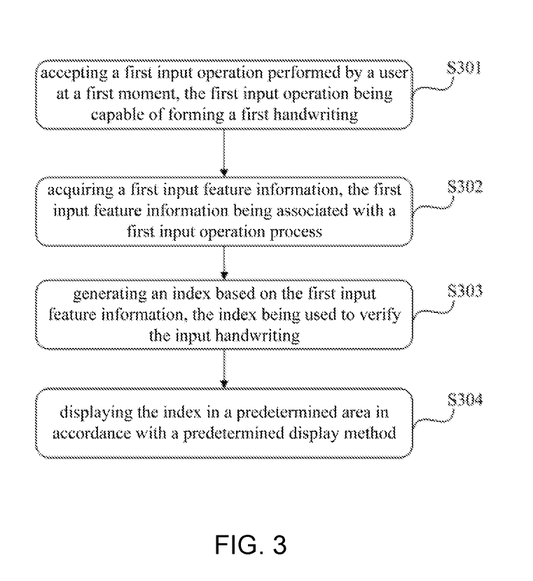

Referring now to FIG. 3, a flow diagram of an information processing method according to an embodiment is illustrated.

At step S301, an embodiment accepts a first input operation performed by a user at a first moment, the first input operation being capable of forming a first handwriting. At step S302, an embodiment acquires a first input feature information, the first input feature information being associated with a first input operation process. At step S303, an embodiment generates an index based on the first input feature information, the index being used to verify the input handwriting.

At step S304, an embodiment displays the index in a predetermined area in accordance with a predetermined display method. After generating the index, the index is displayed based on the predetermined display method, such that the index can be viewed by the user. In an embodiment, the index is displayed in the periphery of the input handwriting. In an embodiment, to-be-signed content and an area having the first comparison are stored, so that the user may subsequently acquire the first input feature information by scanning the index in the form of a QR code or clicking the index in the form of a link. In an embodiment, the to-be-signed content and the area having the first handwriting may be printed, the index being displayed in the printed receipt.

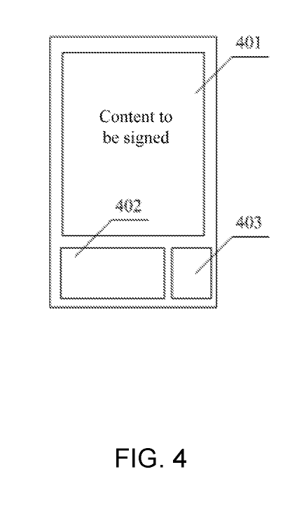

Referring now to FIG. 4, a structural schematic diagram showing a display according to an embodiment is illustrated. The diagram comprises: the to-be-signed content display area 401, the first handwriting input area 402 and the index area 403, wherein the first handwriting is displayed in the first handwriting input area 402. A QR code is displayed in the index area.

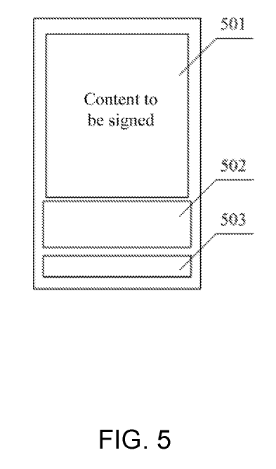

Referring now to FIG. 5, a structural schematic diagram showing a display according to an embodiment is illustrated. The display comprises: the to-be-signed content display area 501, the first handwriting input area 502 and the index area 503, wherein the first handwriting is displayed in the first handwriting input area 502. A website address is displayed in the index area.

In an embodiment, an information processing method further comprises: displaying the index in a predetermined area in accordance with a predetermined display method. With the method, acquiring the first input feature may be realized based on the displayed index. The acquisition method is easy to perform.

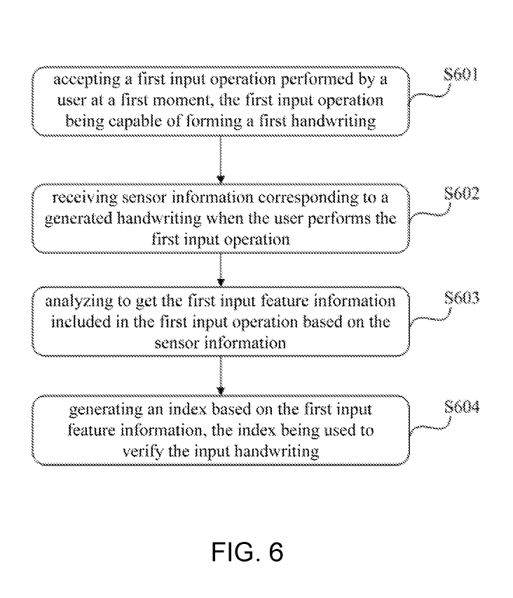

Referring now to FIG. 6, a flow diagram of an information processing method according to an embodiment is illustrated.

At step S601, an embodiment accepts a first input operation performed by a user at a first moment, the first input operation being capable of forming a first handwriting.

At step S602, an embodiment receives sensor information corresponding to a generated handwriting when the user performs the first input operation. The sensor information corresponding to the generated handwriting is received when the user performs the first input operation. More particularly, the sensor information may be various corresponding information when the user performs the first input operation, including: pressure, stroke, speed and the like. In an embodiment, the user may perform the first input operation by using an input tool (e.g., stylus) or by swiping with a hand. More particularly, in an induction apparatus receiving the input operation in an electronic device, detection may be performed on the sensor information, which may also be collected by the input tool, followed by being sent to the electronic device. Accordingly, a corresponding acceleration sensor, pressure sensor and the like may be disposed in the input tool to detect the sensor information.

At step S603, an embodiment analyzes to obtain the first input feature information included in the first input operation based on the sensor information, wherein the first input feature information is associated with a first input operation process. Analysis is made to obtain the first input feature information included in the first input operation based on the sensor information corresponding to a note in the sensor information. It is to be noted that the first input feature information includes a feature in the process in which the first input operation is performed at the first moment to form the first handwriting.

At step S604, an embodiment generates an index based on the first input feature information, the index being used to verify an input handwriting.

Therefore, in an embodiment, in an information processing method provided in the embodiment, the acquiring a first input feature information comprises: receiving sensor information corresponding to a generated handwriting when the user performs the first input operation; analyzing to obtain the first input feature information included in the first input operation based on the sensor information. With the method, simple analysis can be made, based on the sensor information, to obtain the first input feature information included in the first input operation by collecting the sensor information corresponding to the generated handwriting in the first input operation performed by the user. The analysis process is easy to perform.

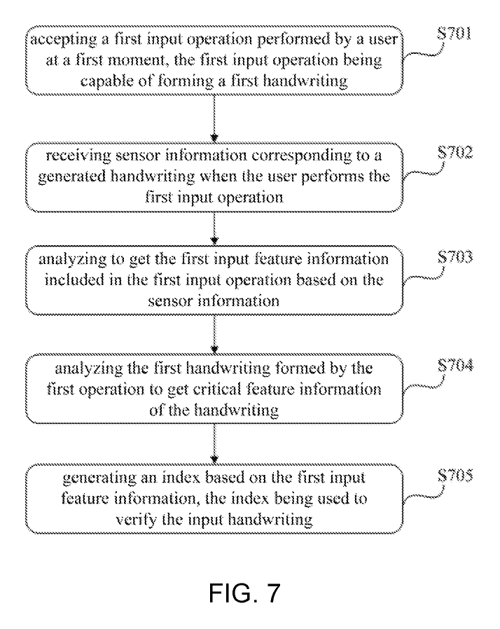

Referring now to FIG. 7, a flow diagram of an information processing method according to an embodiment is illustrated. At step S701, an embodiment accepts a first input operation performed by a user at a first moment, the first input operation being capable of forming a first handwriting. At step S702, an embodiment receives sensor information corresponding to a generated handwriting when the user performs the first input operation. At step S703, an embodiment analyzes to obtain the first input feature information included in the first input operation based on the sensor information; wherein steps S701 to S703 are consistent with steps S601 to S603 in embodiment 4, therefore no description is repeated in the embodiment.

At step S704, an embodiment analyzes the first handwriting formed by the first operation to get critical feature information of the handwriting. The critical feature information of the handwriting may comprise features including a sequence of strokes in the handwriting, a thickness of the handwriting and the like. It is to be noted that the critical feature information of the handwriting represents the sequence and force when the user inputs the handwriting. Based on the thickness of the handwriting, the force with which the user writes the strokes may be known. Writing method and force differ among people, thus analysis may be made to determine whether the writing comes from the same person based on the critical feature information of the handwriting.

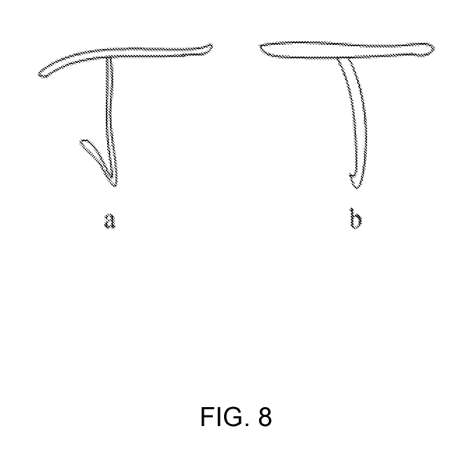

Referring now to FIG. 8, a structural schematic diagram of a display showing two written handwritings according to an embodiment is illustrated. FIG. 8 (above “a”) shows a “T-shaped” Chinese character input by user A, while FIG. 8 (above “b”) shows a “T-shaped” Chinese character input by user B. Both Chinese characters differ in thickness. Analysis may be made for the two characters to confirm that they are written by two different people.

At step S705, an embodiment generates an index based on the first input feature information, the index being used to verify an input handwriting.

Therefore, in an embodiment, in an information processing method the acquiring a first input feature information further comprises: analyzing the first handwriting formed by the first operation to get the critical feature information of the handwriting. With the method, the critical feature information of the handwriting is obtained based on analysis performed on the first handwriting formed by the first operation, analysis may be made to determine whether the handwriting which is input subsequently and the first handwriting are input by the same user based on the critical feature information.

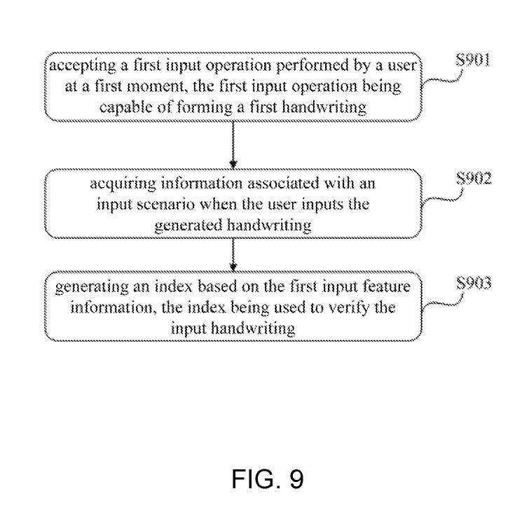

Referring now to FIG. 9, a flow diagram of an information processing method according to an embodiment is illustrated.

At step S901, an embodiment accepts a first input operation performed by a user at a first moment, the first input operation being capable of forming a first handwriting.

At step S902, an embodiment acquires information associated with an input scenario when the user inputs a generated handwriting, wherein a first input feature information comprises environmental information. The information associated with the input scenario may be information associated with a scenario in which the user inputs the generated handwriting, such as information of a signed document, photograph of surroundings during signing and/or sound when signing, pen grasp of the user when inputting the first input operation, specific coordinates of the location of the signing and the like. Accordingly, based on the first input feature information, a situation in which the user inputs a generated note may be recorded, such that a traceable signature process is realized.

At step S903, an embodiment generates an index based on the first input feature information, the index being used to verify an input handwriting.

Therefore, in an embodiment, in an information processing method the first input feature information comprises environmental information, so that the acquiring a first input feature information specifically comprises: acquiring information associated with the input scenario when the user inputs the generated handwriting. With the method, the situation in which the user inputs the generated note may be recorded, such that the signature process is traceable. As such, when dispute occurs because the user denies signature, verification can be performed for the to-be-realized input signature information based on the index, and in turn, the dispute issue is resolved and user experience is improved.

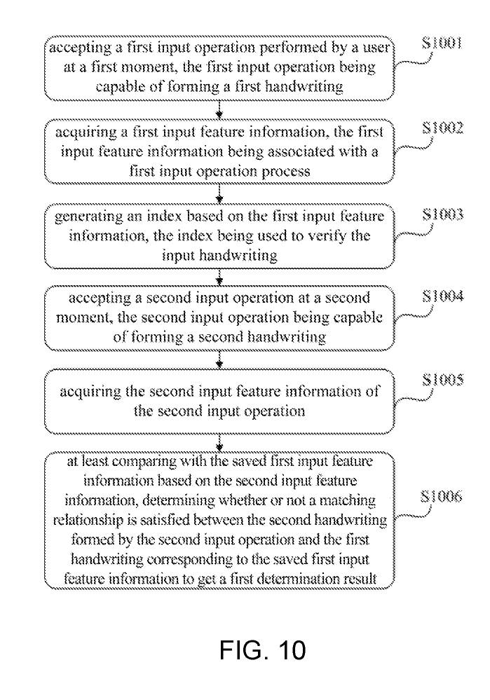

Referring now to FIG. 10, a flow diagram of an information processing method according to an embodiment is illustrated.

At step S1001, an embodiment accepts a first input operation performed by a user at a first moment, the first input operation being capable of forming a first handwriting. At step S1002, an embodiment acquires a first input feature information, the first input feature information being associated with a first input operation process. At step S1003, an embodiment generates an index based on the first input feature information, the index being used to verify the input handwriting.

At step S1004, an embodiment accepts a second input operation at a second moment, the second input operation being capable of forming a second handwriting.

At step S1005, an embodiment acquires a second input feature information of the second input operation; wherein the second moment is a moment similar to the first moment at which the user has to perform signature, such as a moment at which the user swipes a card and signs, a moment at which the user signs for business and the like. The second input feature information is acquired based on the process of the second input operation. More particularly, the second input feature information includes a feature in the process in which the second input operation is performed at the second moment to form the second handwriting. In an embodiment, an analysis can be made to obtain the user who performs the second input operation and a feature in the process in which the user performs the second input operation based on the second input feature information.

At step S1006 an embodiment comprises at least comparing with the saved first input feature information based on the second input feature information, determining whether a matching relationship is satisfied between the second handwriting formed by the second input operation and the first handwriting corresponding to the saved first input feature information to get a first determination result.

The second input feature represents inputting information associated with the second handwriting, at least comparing it with the first input feature information previously saved and determining, based on the comparison result, whether a matching relationship is satisfied between the second handwriting formed by the second input operation and the first handwriting corresponding to the saved first input feature information. More particularly, when the comparison result of the second input feature information and the first input feature information is analogous, a satisfied predetermined matching relationship between the second handwriting and the first handwriting may be identified based on the comparison result, so that the second handwriting and the first handwriting are signed by the same person.

In an embodiment, as the first handwriting is identified as a signature of a legal user, the second handwriting and the first handwriting are signed by the same person, thus the signature corresponding to the second handwriting is valid. In an embodiment, a signature of a certain person may have a certain alteration, thus not only the second input feature information is compared with the first input feature information, but also other schemes may be adopted by comparing the second input feature information with other input feature information belonging to a certain legal user to perform determination by combining several comparison results.

For example, in an embodiment, the scheme may be realized in an electronic device where signature occurs, for example, on a merchant POS machine and a bank electronic signature apparatus. As a user completes a signature, whether the signature is legal is determined automatically. More particularly, the saved first input feature information corresponding to a user name corresponding with a signed name and a bank card and the like is acquired, and the input feature information corresponding to the signature is determined based on the first input feature information to identify whether both corresponding signature handwritings come from the same person. If yes, the business is completed, otherwise, a prompt may be generated to alert the merchant or bank staff.

Therefore, in an embodiment, an information processing method further comprises: accepting a second input operation at a second moment, the second input operation being capable of forming a second handwriting; acquiring the second input feature information of the second input operation; at least comparing with the saved first input feature information based on the second input feature information, determining whether a matching relationship is satisfied between the second handwriting formed by the second input operation and the first handwriting corresponding to the saved first input feature information to get a first determination result. With the method, the input feature information of the second input operation accepted at the second moment different from the first moment is at least compared with the saved first input feature information to realize determination with respect to whether a matching relation is satisfied between the second handwriting formed by the second input operation and the first handwriting corresponding to the saved first input feature information, thus the determination process is meticulous, but accuracy is higher.

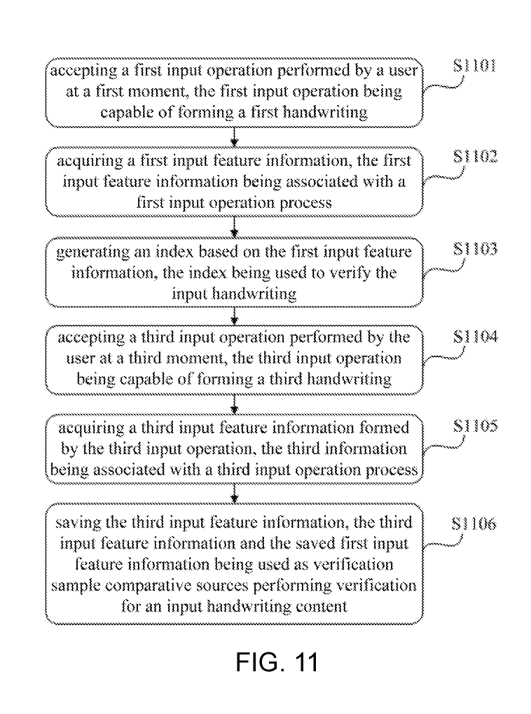

Referring now to FIG. 11, a flow diagram of an information processing according to an embodiment is illustrated.

At step S1101, an embodiment accepts a first input operation performed by a user at a first moment, the first input operation being capable of forming a first handwriting. At step S1102, an embodiment acquires a first input feature information, the first input feature information being associated with a first input operation process. At step S1103, an embodiment generates an index based on the first input feature information, the index being used to verify the input handwriting.

At step S1104, an embodiment accepts a third input operation performed by the user at a third moment, the third input operation being capable of forming a third handwriting; wherein the third moment and the first moment are different moments. More particularly, the third input operation performed by the user is received at the third moment. The third input operation is also a legal input of the user. The input may be an input operation performed at a different time and/or a different place compared to the first input operation.

At step S1105, an embodiment acquires a third input feature information formed by the third input operation, the third information being associated with a third input operation process, wherein the third input feature information is acquired based on the process of the third input operation. More particularly, the third input feature information includes a feature in the process in which the third input operation is performed at the third moment to form the third handwriting. In an embodiment, an analysis can be made to obtain the user who performs the third input operation and a feature in the process in which the user performs the third input operation based on the third input feature information.

At step S1106, an embodiment saves the third input feature information, the third input feature information and the saved first input feature information being used as verification sample comparative sources for performing verification for an input handwriting content. It is to be noted that there is no relationship between the third input operation performed at the third moment and the first input operation performed at the first moment, each are independently saved without replacement operation there between.

The verification sample comparative sources can include multiple input feature information, which may be legal input operations performed by the same legal user at different times and/or different places. In an embodiment, the input feature information included in the verification sample comparative sources may be the input feature information of the input operation performed by the user within a very long time period, for example, several years.

Therefore, in an embodiment, an information processing method further comprises: accepting a third input operation performed by the user at a third moment, the third input operation being capable of forming a third handwriting; acquiring a third input feature information formed by the third input operation, the third information being associated with a third input operation process; saving the third input feature information, the third input feature information and the saved first input feature information being used as verification sample comparative sources performing verification for an input handwriting content. With the method, based on the third input operation, which is performed by the user, received at the third moment different from the first moment, together with acquiring the third input feature information formed by the third input operation, the third input feature information and the previous first input feature information are independently saved to provide multiple verification samples for subsequent verifications performed for input handwritings, thus accuracy of verification is improved.

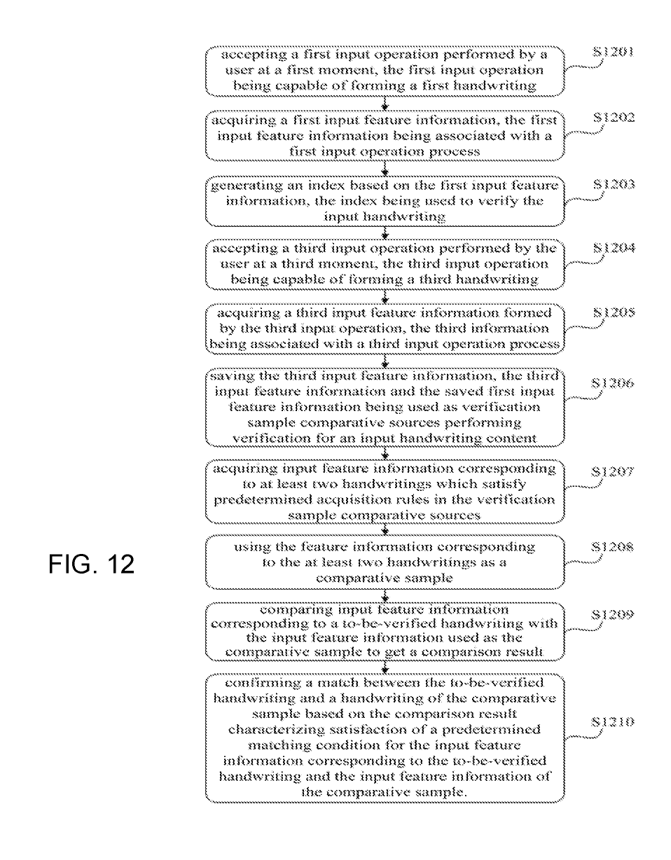

Referring now to FIG. 12, a flow diagram of an information processing method provided according to an embodiment is illustrated.

At step S1201, an embodiment accepts a first input operation performed by a user at a first moment, the first input operation being capable of forming a first handwriting. At step S1202, an embodiment acquires a first input feature information, the first input feature information being associated with a first input operation process. At step S1203, an embodiment generates an index based on the first input feature information, the index being used to verify the input handwriting. At step S1204, an embodiment accepts a third input operation performed by the user at a third moment, the third input operation being capable of forming a third handwriting. At step S1205, an embodiment acquires a third input feature information formed by the third input operation, the third information being associated with a third input operation process.

At step S1206, an embodiment saves the third input feature information. The third input feature information and the saved first input feature information being used as verification sample comparative sources performing verification for an input handwriting content.

At step S1207, an embodiment acquires input feature information corresponding to at least two handwritings that satisfy predetermined acquisition rules in the verification sample comparative sources.

At step S1208, an embodiment uses the feature information corresponding to the at least two handwritings as a comparative sample, wherein input feature information corresponding to multiple handwritings is included in the verification sample comparative sources. More particularly, the input feature information corresponding to at least two handwritings is acquired from the verification sample comparative sources in accordance with predetermined acquisition rules.

In an embodiment, there may be multiple approaches for the acquiring input feature information. A first approach is acquiring, based on a time sequence of the generated handwritings, input feature information corresponding to N handwritings generated in a most recent period from generation of the to-be-verified handwriting, N being an integer greater than or equal to 2. It is to be noted that adoption of this approach can guarantee consistency between the verification sample and the recent signing habits of the user. Another approach is separately acquiring input operation feature information corresponding to N handwritings in at least two predetermined time periods, N being an integer greater than or equal to 2. It is to be noted that one piece is extracted every few years (e.g., two years) with a time span satisfied for this approach, thus the time span is longer to avoid conspiratorial forging occurring when the most recent 2 years is particularly examined. A still further approach is acquiring input operation feature information corresponding to at least two handwritings associated with a first factor based on the first factor in the information associated with the input scenario. It is to be noted that this approach can be adopted to perform verification of a certain place (e.g., a certain GPS site), or bill signing of a certain bank. For example, bill signing verified for a certain fixed merchant/bank outlet; or bill signing verified for a certain bank, such as ICBC (Industrial and Commercial Bank of China).

At step S1209, an embodiment compares input feature information corresponding to a to-be-verified handwriting with the input feature information used as the comparative sample to get a comparison result, wherein the input feature information corresponding to the to-be-verified handwriting is acquired for comparing the feature information and feature information of the comparative sample to get a comparison result.

At step S1210, an embodiment confirms a match between the to-be-verified handwriting and handwriting of the comparative sample based on the comparison result characterizing satisfaction of a predetermined matching condition for the input feature information corresponding to the to-be-verified handwriting and the input feature information of the comparative sample. In an embodiment, the comparison result may be expressed by way of a matching value, the input feature information may include the sensor information corresponding to the handwriting and the critical feature information of the handwriting, so that a final matching value is calculated based on a matching degree of the sensor information of the handwriting and the matching degree of the critical feature information of the handwriting.

The critical feature information of the handwriting represents the sequence and force when the user inputs the handwriting. Based on the thickness of the handwriting, the force with which the user writes the stroke may be known. The sensor information may be various corresponding information when the user performs the first input operation, including, pressure, stroke, speed and the like. More particularly, the calculated matching value is greater than a default matching threshold, thus the comparison result may represent that the input feature information corresponding to the to-be-verified handwriting and the input feature information of the comparative sample satisfy a predetermined match condition; otherwise, the input feature information corresponding to the to-be-verified handwriting and the input feature information of the comparative sample do not satisfy the predetermined match condition.

Accordingly, the person who inputs the to-be-verified handwriting and the person who inputs the handwriting of the comparative sample are identical based on confirmation of a match between the to-be-verified handwriting and a handwriting of the comparative sample based on the comparison result characterizing satisfaction of a predetermined matching condition for the input feature information corresponding to the to-be-verified handwriting and the input feature information of the comparative sample; otherwise, they are different.

Therefore, in an embodiment, an information processing method performing verification for an input handwriting comprises: acquiring input feature information corresponding to at least two handwritings which satisfy predetermined acquisition rules in the verification sample comparative sources; using the feature information corresponding to the at least two handwritings as a comparative sample; comparing input feature information corresponding to a to-be-verified handwriting with the input feature information used as the comparative sample to get a comparison result; confirming a match between the to-be-verified handwriting and a handwriting of the comparative sample based on the comparison result characterizing satisfaction of a predetermined matching condition for the input feature information corresponding to the to-be-verified handwriting and the input feature information of the comparative sample. With the method, based on the feature information corresponding to the multiple handwritings used as comparative samples in the verification sample comparative sources, verification is performed for the to-be-verified handwriting, thus there are more comparative samples to improve accuracy of verification.

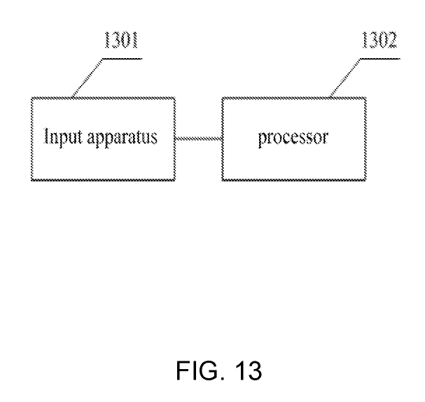

Referring now to FIG. 13, a schematic structural block diagram of an electronic device according to an embodiment is illustrated. The electronic device may be an electronic device in the form of a desktop, a notebook, a tablet computer, a mobile phone, a smart TV, a smart watch, a wearable device and the like, and the electronic device is capable of performing an operation of inputting handwriting. The electronic device comprises the following structure: an input apparatus 1301 and a processor 1302. The input apparatus 1301 is used for receiving an input operation performed by a user, wherein the input apparatus may be a touch device, a touch screen, a stylus and the like, which is a device capable of performing the input operation.

The processor 1302 is used for accepting a first input operation performed by the user at a first moment, the first input operation being capable of forming a first handwriting; acquiring a first input feature information, the first input feature information being associated with a first input operation process; generating an index based on the first input feature information, the index being used to verify the input handwriting.

In an embodiment a processor may be a structure having a chip and the like capable of information processing in the electronic device, such as a CPU (Central Processing Unit), EC (Embedded Controller) and the like.

Therefore, in an embodiment, an electronic device performs acquisition for the first input feature information associated with the first input operation process which forms the first handwriting and generates an index based on the first input feature information to realize performing verification for the input handwriting content based on the index. Thereby, a traceable signature process is realized. As such, when the dispute occurs because the user denies signature, verification can be performed for the to-be-realized input signature information based on the index, and in turn, the dispute issue is resolved and user experience is improved.

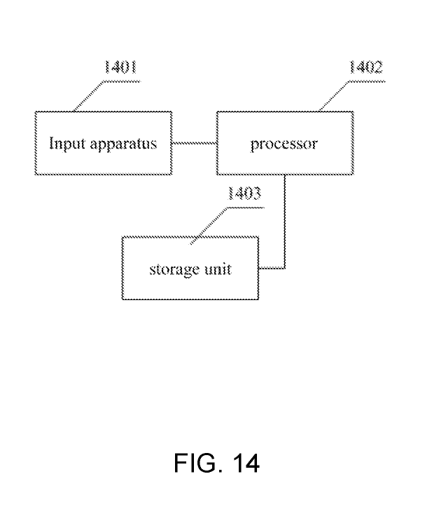

Referring now to FIG. 14, a schematic structural block diagram of an electronic device according to an embodiment is illustrated. The electronic device comprises the following structure: an input apparatus 1401, a processor 1402 and storage 1403. The storage 1403 is used for storing the first input feature information, wherein the processor 1402 is further used for generating an index based on the storage location, the index being used to acquire the first input feature information from the storage location.

The index is generated from the storage location so that the first input feature information can be acquired from the storage location based on the index, and in turn, verification can be performed for the first input feature information at a subsequent time, or verification is performed for the input feature information of other tracks based on the first input feature information.

Therefore, in an embodiment, in the electronic device, the index is generated based on the save location which stores the first input feature information such that performing verification for the stored first input feature information, or performing verification for the input feature information of other tracks based on the first input feature information can be realized.

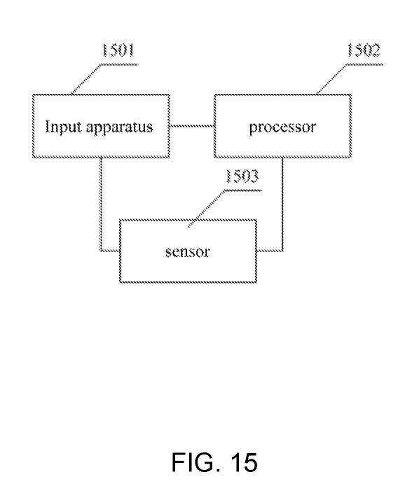

Referring now to FIG. 15, a schematic structural block diagram of an electronic device according to an embodiment is illustrated. The electronic device comprises the following structures: an input apparatus 1501, a processor 1502 and a sensor 1503. The sensor 1503 is used for collecting sensor information corresponding to the generated handwriting when the user performs the first input operation, wherein the processor 1502 is further used for analyzing to obtain the first input feature information included in the first input operation based on the sensor information.

More particularly, the sensor information may be various corresponding information when the user performs the first input operation, including, pressure, stroke, speed and the like. In an embodiment, the user may perform the first input operation by using an input tool (e.g., stylus) or by swiping with a hand. Accordingly, acceleration sensor, pressure sensor and the like may be used by the sensor to detect the sensor information. In an embodiment, the sensor information may further be detected by an input tool which performs the input operation followed by sending the detected sensor information to a processor of the electronic device. That is, the input apparatus and the sensor may be the same equipment.

Therefore, in an embodiment, in an electronic device, simple analysis can be made, based on the sensor information, to obtain the first input feature information included in the first input operation by collecting the sensor information corresponding to a generated handwriting in the first input operation performed by the user. The analysis process is easy to perform.

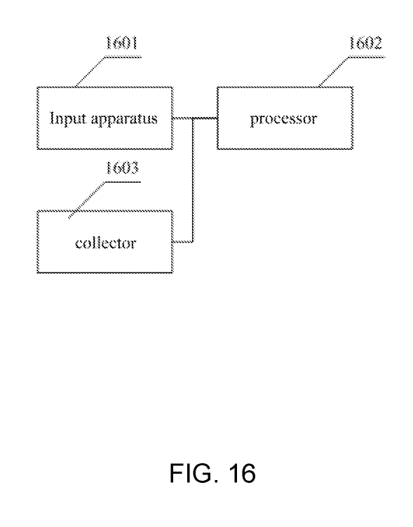

Referring now to FIG. 16, a schematic structural block diagram of an electronic device according to an embodiment is provided. The electronic device comprises the following structure: an input apparatus 1601, a processor 1602 and a collector 1603. The collector 1603 is used for acquiring information associated with an input scenario when the user inputs the generated handwriting.

The information associated with the input scenario may be information associated with a scenario in which the user inputs the generated handwriting, such as information of a signed document, photograph of surroundings during signing and/or sound when signing, pen grasp of the user when inputting the first input operation, specific coordinates of the location of the signing and the like.

Accordingly, based on the first input feature information, a situation in which the user inputs a generated note may be recorded, such that a traceable signature process is realized. Accordingly, the collector may be realized by using a camera, a microphone (mic), a GPS (Global Positioning System) module and the like.

Therefore, in an embodiment, in an electronic device, information associated with an input scenario when the user inputs the generated handwriting is acquired to record the situation in which the user inputs the generated note, such that the signature process is traceable. As such, when dispute occurs because the user denies signature, verification can be performed for the to-be-realized input signature information based on the index, and in turn, the dispute issue is resolved and user experience is improved.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
receiving, at an electronic device, a handwriting input operation by a user;
acquiring, using a processor, a first input feature information associated with the handwriting input operation; and
generating, using a processor, an index based on the first input feature information.

2. The method of claim 1, wherein the handwriting input operation comprises signature input.

3. The method of claim 1, wherein the first input feature information is recorded in the index, the index being used to retrieve the first input feature information.

4. The method of claim 3, further comprising storing the index at a storage location accessible by the electronic device.

5. The method of claim 1, further comprising displaying the index in a predetermined area of a display.

6. The method of claim 1, wherein the acquiring further comprises:
receiving, at a sensor, sensor data associated with the handwriting input operation;
analyzing, using a processor, the received sensor data; and
acquiring, based on the analyzing, the first input feature information.

7. The method of claim 6, further comprising analyzing the first input feature information to obtain handwriting feature data associated with the handwriting input operation.

8. The method of claim 7, wherein the handwriting feature data comprises data associated with a geographic location of the handwriting input operation.

9. The method of claim 1, further comprising:
receiving, at the electronic device, another handwriting input operation;
acquiring, using a processor, a second input feature information, wherein the second input feature information is associated in time with the another handwriting input operation;
comparing the first input feature information and the second input feature information; and
determining that the first input operation matches with the another input operation.

10. The method of claim 9, further comprising creating, based on the determining, a verification sample by saving the second input feature information if the second input feature information is determined to match with the first input feature information.

11. The method of claim 10, further comprising:
acquiring input feature information corresponding to at least two handwriting inputs that satisfy predetermined acquisition rules;
using the feature information corresponding to the at least two handwriting inputs as a comparative sample;
comparing input feature information corresponding to a to-be-verified handwriting input with an input feature information used as the comparative sample to obtain a comparison result; and
confirming a match between the to-be-verified handwriting input and the input feature information used as the comparative sample based on the comparison result characterizing satisfaction of a predetermined matching condition for the input feature information corresponding to the to-be-verified handwriting and the input feature information of the comparative sample.

12. The method according to claim 11, wherein the acquiring input feature information corresponding to at least two handwriting inputs that satisfy predetermined acquisition rules comprises:
acquiring the input feature information corresponding to N handwritings generated in a most recent period from generation of the to-be-verified handwriting input based on a time sequence of the generated handwritings, N being an integer greater than or equal to 2.

13. An electronic device, comprising:
a handwriting input component;
a processor operatively coupled to the handwriting input component;
a memory device that stores instructions executable by a processor to:
receive a handwriting input operation by a user;
acquire a first input feature information associated with the handwriting input operation; and
generate an index based on the first input feature information.

14. The electronic device of claim 13, wherein the handwriting input operation comprises signature input.

15. The electronic device of claim 13, wherein the first input feature information is recorded in the index, the index being used to retrieve the first input feature information.

16. The electronic device of claim 15, wherein a processor executes instructions to store the index at a storage location accessible by the electronic device.

17. The electronic device of claim 13, further comprising a sensor;
wherein a processor executes instructions to:
receive, from the sensor, sensor data associated with the handwriting input operation;
analyze the received sensor data; and
acquire, based on the analysis of the sensor data, the first input feature information.

18. The electronic device of claim 17, wherein a processor executes instructions to analyze the first input feature information to obtain handwriting feature data associated with the handwriting input operation.

19. The electronic device of claim 13, wherein a processor executes instructions to:
receive another handwriting input operation;
acquire a second input feature information, wherein the second input feature information is associated in time with the another handwriting input operation;
compare the first input feature information and the second input feature information; and
determine that the first input operation matches with the another input operation.

20. A program product, comprising:
a storage device that stores code, the code being executable by a processor and comprising:
code that receives, at an electronic device, a handwriting input operation by a user;
code that acquires, using a processor, a first input feature information associated with the handwriting input operation; and
code that generates, using a processor, an index based on the first input feature information.
